(19) United States
(12) Patent Application Publication
(10) Pub. No.: US 2024/0212193 A1
(43) Pub. Date: Jun. 27, 2024

(54) IMAGE PROCESSING APPARATUS, METHOD OF GENERATING TRAINED MODEL, IMAGE PROCESSING METHOD, AND MEDIUM

(71) Applicant: CANON KABUSHIKI KAISHA, Tokyo (JP)

(72) Inventors: Tomoyuki TENKAWA, Chiba (JP); Yuichi KAGEYAMA, Kanagawa (JP); Tomoki TAMINATO, Kanagawa (JP)

(21) Appl. No.: 18/393,972

(22) Filed: Dec. 22, 2023

(30) Foreign Application Priority Data
Dec. 27, 2022 (JP) 2022-210202

(51) Int. Cl. G06T 7/70; G06V 10/74; G06V 40/16

(52) U.S. Cl. CPC G06T 7/70; G06V 10/761; G06V 40/165; G06T 2207/20081; G06V 2201/07

(57) ABSTRACT

An image processing apparatus is provided. First position estimation is performed to detect one or more parts of a first type in an image. A distance between each of the one or more parts of the first type and a part of a second type in the image is estimated. From among the one or more parts of the first type detected, one part of the first type is selected based on the distance estimated for each of the parts of the first type. Information indicating the part selected is output.

### BACKGROUND OF THE INVENTION

### Field of the Invention

The present invention relates to an image processing apparatus, a method for generating a trained model, an image processing method, and a medium, and particularly relates to an automatic focus control.

### Description of the Related Art

Current cameras have automatic focus control (AF, or “autofocus”) functions. In an AF function, a shooting lens is automatically controlled to bring a subject into focus. Particularly when shooting a person, an animal, or the like, there is a need to focus on the eyes or the pupils in the eyes (this will be referred to simply as the “eyes” hereinafter). Such a configuration is useful for shooting headshots that leave an impression.

Japanese Patent Laid-Open No. 2012-123301 (“Kunishige”) discloses a pupil detection AF mode. In this mode, an eye is detected from an image that is shot. The focus is then adjusted so as to focus on the eye. The technique of Kunishige aims to achieve good focus on the eye. To that end, Kunishige discloses detecting the orientation of a face and focusing on the eye which can be more easily detected based on that orientation. Specifically, the eye that is closer to the photographer (camera) is brought into focus.

Many methods for detecting objects in shot images have been proposed in recent years. Among these, techniques using multilayer neural networks called deep nets (also referred to as “deep neural networks” and “deep learning”) are being actively studied. Such techniques involve training networks on the features of objects within images. The training results are then used to recognize the positions or types of objects. For example, J. Deng et al., “RetinaFace: Single-shot Multi-level Face Localisation in the Wild”, CVPR 2020 (“Deng”) discloses a technique for detecting facial organs from images using a deep net. In addition, K. Khabarlak et al., “Fast Facial Landmark Detection and Applications: A Survey”, CVPR 2021 (“Khabarlak”) lists direct regression and heat maps as methods for estimating organ points on a face.

### SUMMARY OF THE INVENTION

According to an embodiment of the present invention, an image processing apparatus comprises one or more memories storing instructions and one or more processors that execute the instructions to: perform first position estimation of detecting one or more parts of a first type in an image; estimate a distance between each of the one or more parts of the first type and a part of a second type in the image; select, from among the one or more parts of the first type detected, one part of the first type, based on the distance estimated for each of the parts of the first type; and output information indicating the part selected.

According to another embodiment of the present invention, an image processing apparatus comprises one or more memories storing instructions and one or more processors that execute the instructions to: obtain an image; and detect a part of a first type in an image that is a closer part closer to an image capturing apparatus that captured the image than another part of the first type in the image, using a trained model having parameters trained to estimate the closer part in an image, and output information indicating a detection result.

According to still another embodiment of the present invention, a method of generating a trained model having parameters trained to be used to estimate a distance between a part of a first type and a part of a second type in an image comprises: obtaining (i) a training image and (ii) a ground truth map in which information indicating the distance between each of the part of the first type and the part of the second type is provided at a position corresponding to the part of the first type in the training image; and training the parameters of the trained model based on (i) a map indicating the distance from the part of the first type to the part of the second type in the training image, the map being obtained by inputting the training image into the trained model, and (ii) the ground truth map.

According to yet another embodiment of the present invention, a method of generating a trained model having parameters trained to be used to estimate a position of a part of a first type in an image, the part being closer to an image capturing apparatus that captured the image than another part of the first type in the image, comprises: obtaining (i) a training image including a plurality of parts of the first type and (ii) a ground truth map in which is labeled a position corresponding to a part, among the plurality of parts of the first type in the training image, selected such that a distance from the part to a part of a second type is longer than a distance from the other part of the first type to the part of the second type; and training the parameters of the trained model based on (i) a map indicating a likelihood that a part closer to the image capturing apparatus that captured the image than the other part of the first type is present for the training image, the map being obtained by inputting the training image into the trained model; and (ii) the ground truth map.

According to still yet another embodiment of the present invention, an image processing method comprises: performing first position estimation of detecting one or more parts of a first type in an image; estimating a distance between each of the one or more parts of the first type and a part of a second type in the image; selecting, from among the one or more parts of the first type detected, one part of the first type, based on the distance estimated for each of the parts of the first type; and outputting information indicating the part selected.

According to yet still another embodiment of the present invention, a non-transitory computer-readable medium stores one or more programs which are executable by a computer comprising one or more processors and one or more memories to perform a method comprising: performing first position estimation of detecting one or more parts of a first type in an image; estimating a distance between each of the one or more parts of the first type and a part of a second type in the image; selecting, from among the one or more parts of the first type detected, one part of the first type, based on the distance estimated for each of the parts of the first type; and outputting information indicating the part selected.

Further features of the present invention will become apparent from the following description of exemplary embodiments (with reference to the attached drawings).

### BRIEF DESCRIPTION OF THE DRAWINGS

FIG. 1 is a diagram illustrating an example of the hardware configuration of a camera according to an embodiment.

FIGS. 2A to 2C are diagrams illustrating an example of the functional configuration of an image processing apparatus according to an embodiment.

FIG. 3 is a flowchart illustrating the flow of processing in an image processing method according to an embodiment.

FIG. 4 is a diagram illustrating an example of the structure of a neural network used in an embodiment.

FIG. 5 is a diagram illustrating an example of the functional configuration of a training apparatus according to an embodiment.

FIGS. 6A and 6B are schematic diagrams illustrating a relationship between the orientation of a face and a distance between an eye and a nose.

FIGS. 7A to 7E are schematic diagrams illustrating relationships between training images and ground truth information.

FIG. 8 is a flowchart illustrating the flow of processing in a training method according to an embodiment.

FIG. 9 is a diagram illustrating an example of the structure of a neural network used in an embodiment.

FIG. 10 is a flowchart illustrating the flow of processing for creating supervisory data.

FIG. 11 is a flowchart illustrating the flow of processing in an image processing method according to an embodiment.

FIG. 12 is a diagram illustrating an example of the structure of a neural network used in an embodiment.

FIGS. 13A to 13D are schematic diagrams illustrating a ground truth map for the center position of an eye that is closer to a camera.

FIGS. 14A to 14C are schematic diagrams illustrating relationships between training images and ground truth information.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The following will describe a camera as an example of an image capturing apparatus according to the present invention. However, the embodiment described below can be applied in any electronic device that detects an object region in an image or moving image. Such electronic devices include personal computers, mobile phones, dashboard cameras, robots, drones, and the like that have camera functions, in addition to image capturing apparatuses such as digital cameras or digital video cameras. The electronic device is not limited thereto, however. Such an electronic device can include an image processing unit 104 (described later).

### Hardware Configuration

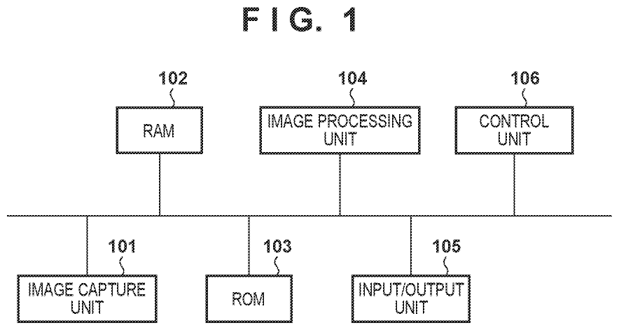

FIG. 1 illustrates an example of the hardware configuration of a camera 100 serving as an image capturing apparatus according to an embodiment. The camera according to the present embodiment includes an image capture unit 101, a RAM 102, a ROM 103, the image processing unit 104, an input/output unit 105, and a control unit 106. These units are configured to be capable of communicating with each other, and are connected to each other by a bus or the like.

The image capture unit 101 can capture images. The image capture unit 101 can include a shooting lens, an image sensor, an A/D converter, an aperture control unit, and a focus control unit. The shooting lens can include a fixed lens, a zoom lens, a focus lens, an aperture stop, and an aperture motor. The image sensor converts an optical image of a subject into an electrical signal. The image sensor can include a CCD, a CMOS, or the like. The A/D converter converts analog signals into digital signals. The aperture control unit changes the diameter of the aperture stop by controlling the operation of the aperture motor. In this manner, the aperture control unit can control the aperture of the shooting lens. The focus control unit controls the focus state of the shooting lens by driving the focus lens. The focus control unit can control the operation of the focus motor based on a phase difference between a pair of focus detection signals obtained from the image sensor. Here, the focus control unit can control the focus to bring a designated AF region into focus.

In the image capture unit 101, the image sensor converts a subject image formed on an image forming surface of the image sensor by the shooting lens into an electrical signal. The A/D converter generates image data by applying A/D conversion processing to the obtained electrical signal. The image data obtained in this manner is supplied to the RAM 102.

The RAM 102 stores the image data obtained by the image capture unit 101. The RAM 102 can also store image data for display in the input/output unit 105. The RAM 102 is provided with a storage capacity sufficient to store a predetermined number of still images or a predetermined time's worth of moving images. The RAM 102 can also function as an image display memory (video memory). At this time, the RAM 102 can supply display image data to the input/output unit 105. The RAM 102 is a volatile memory, for example.

The ROM 103 is a non-volatile memory. The ROM 103 is a storage device such as a magnetic storage device and a semiconductor memory. The ROM 103 can store programs used for the operations of the image processing unit 104 and the control unit 106. The ROM 103 can also hold data which is to be stored for long periods of time.

The image processing unit 104 performs image processing for detecting an object region from an image. The image processing unit 104 can detect object candidate regions from an image, select an object region from the object candidate regions, and output the result. The image processing unit 104 can detect a part (object region) in an image for a specific type of object, i.e., a specific type of part in the image. The object to be detected can be a specific type of object, such as a person, an animal, or a vehicle, or a specific type of a local part included in such an object, such as a head, a face, or an eye. In the present embodiment, the image processing unit 104 outputs, as a detection result, the positions and sizes of candidate regions for a specific type of object, as well as a likelihood that the object is of the specific type. The object region in the image is detected based on this information. The configuration and operations of the image processing unit 104 will be described in detail later.

The input/output unit 105 includes an input device through which a user inputs instructions to the camera 100, and a display in which text or images can be displayed. The input device can include one or more of a switch, a button, a key, and a touch panel. The display can be an LCD or an organic EL display. Inputs made through the input device can be detected by the control unit 106 through the bus. At this time, the control unit 106 controls the various units to implement operations corresponding to the inputs. In addition, a touch detection surface of the touch panel may be used as a display surface for the display. The touch panel is not limited to a specific type, and may use resistive film, electrostatic capacitance, or a light sensor, for example. The input/output unit 105 may display a live view image. In other words, the input/output unit 105 can sequentially display the image data obtained by the image capture unit 101.

The control unit 106 is a processor. The control unit 106 may be a central processing unit (CPU). The control unit 106 can implement the functions of the camera 100 by executing programs stored in the ROM 103. Additionally, the control unit 106 can control the image capture unit 101 to control the aperture, focus, and exposure. For example, the control unit 106 executes automatic exposure (AE) processing for automatically determining the exposure conditions (shutter speed or accumulation time, aperture value, and sensitivity). Such AE processing can be performed based on information about a subject brightness in the image data obtained by the image capture unit 101. The control unit 106 can also automatically set the AF region by using the result of the object region detection by the image processing unit 104. In this manner, the control unit 106 can implement the tracking AF processing for a desired subject region. Note that the AE processing can be performed based on brightness information from the AF region. Furthermore, the control unit 106 can perform image processing (such as gamma correction processing or auto white balance (AWB) adjustment processing). Such image processing can be performed based on the pixel values from the AF region.

The control unit 106 can also control the display by controlling the input/output unit 105. For example, the control unit 106 can display an indicator indicating the position of an object region or an AF region (e.g., a rectangular frame surrounding that region) superimposed on a displayed image. The display of such an indicator can be performed based on the result of the image processing unit 104 detecting the object region or the AF region.

### Functional Configuration

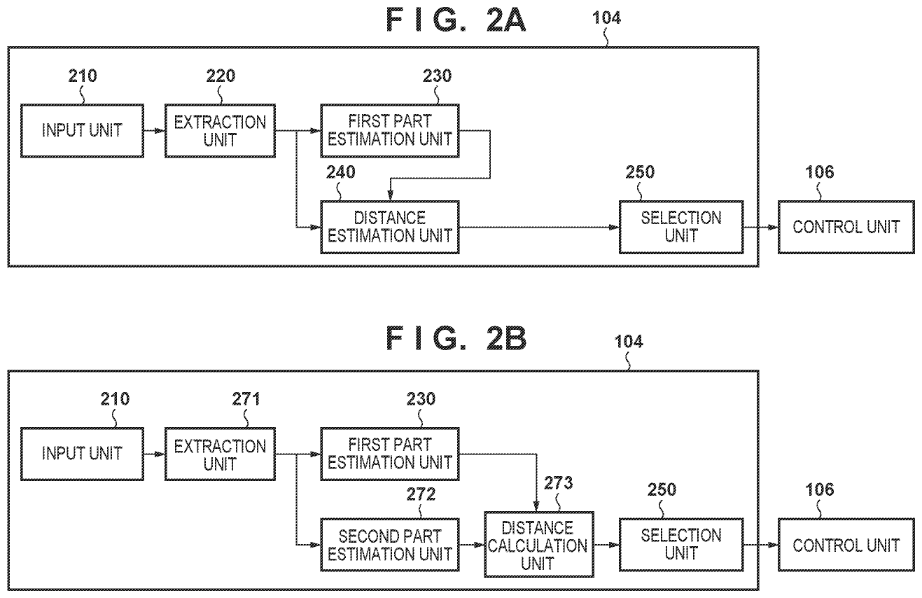

FIG. 2A illustrates the functional configuration of the image processing unit 104, which is an image processing apparatus according to an embodiment. The image processing unit 104 includes an input unit 210, an extraction unit 220, a first part estimation unit 230, a distance estimation unit 240, and a selection unit 250. Note that the image processing unit 104 may be a processing unit that is independent from the control unit 106. For example, the image processing unit 104 may be implemented as dedicated hardware such as an ASIC. The image processing unit 104 may also be a processor which includes a memory or is connected to a memory. In this case, the functions of the units indicated in FIGS. 2A to 2C and the like can be implemented by the processor executing programs stored in the memory. On the other hand, the functions of the image processing unit 104 may be implemented by the control unit 106. In this manner, some or all of the functions of the image processing unit 104 can be realized by a combination of a processor and a memory, or by dedicated hardware. Note that the image processing apparatus according to an embodiment may be constituted by a plurality of information processing apparatuses connected over a network, for example.

The input unit 210 obtains an image. This image can be an image captured by the image capture unit 101. For example, the input unit 210 can obtain frame images included in a time-series moving image obtained by the image capture unit 101. The input unit 210 can obtain image data with a resolution of 1,600×1,200 pixels, at a framerate of 60 fps, in real time, for example.

The extraction unit 220 extracts features from the image obtained by the input unit 210. In the present embodiment, the features of the image are expressed as maps. However, the method for extracting the features is not particularly limited. The extraction unit 220 can extract the features through processing performed according to predetermined parameters. For example, the extraction unit 220 can extract the feature through processing that uses a neural network. The parameters used in the processing performed by the extraction unit 220, such as weighting parameters of the neural network, can be determined through training (described later). The extraction unit 220 may also calculate feature vectors by aggregating colors or textures of pixels.

The first part estimation unit 230 detects a part of a first type in the image. For example, the first part estimation unit 230 can detect a position of a part of the first type in the image. Specifically, the first part estimation unit 230 can determine the position of the part of the first type based on a likelihood of the part of the first type at each of positions in the image. The first part estimation unit 230 can detect the part of the first type based on the features of the image extracted by the extraction unit 220.

In the embodiment described below, the part of the first type is an eye of a person. In this case, the extraction unit 220 can extract information for estimating an eye region from the image as a feature. The feature may be a center position map indicating the likelihood of positions in the image being the center of a frame indicating the eye region, for example. The first part estimation unit 230 can estimate the center position of the eye based on such a feature.

The feature may also be a size map indicating estimated values for the width and height of a frame indicating the eye region for positions in the image. The first part estimation unit 230 can estimate the width and height of a frame corresponding to the estimated center position of the eye based on such a feature.

Such processing makes it possible for the first part estimation unit 230 to select a frame having a high likelihood of representing the center of a frame indicating the eye from among a plurality of frames. The first part estimation unit 230 can select one or two frames, for example.

The distance estimation unit 240 estimates a distance between the part of the first type and a part of a second type in the image. The distance estimation unit 240 can detect the part of the first type based on the features of the image extracted by the extraction unit 220. The feature may be a distance map. The distance map can indicate a distance, to a part of a second type, from the part of the first type in the image. Such a distance map may indicate distances (e.g., Euclidean distances) to the part of the second type for positions in the image. As will be described later, such a distance map can be obtained by the extraction unit 220 using a trained model. In this manner, the extraction unit 220 can extract information for estimating the distance between an eye and a nose as a feature from the image. The distance estimation unit 240 can then estimate a distance from a center position of each of the two frames selected by the first part estimation unit 230 to the nose. In the present embodiment, the part of the first type and the part of the second type are parts belonging to the same object (e.g., a person). Note also that the following will also refer to the part of the second type simply as the “second part”.

The selection unit 250 selects one part of the first type from the detected plurality of parts of the first type based on the estimated distance for each part of the first type. The selection unit 250 then outputs information indicating the selected part. The selection unit 250 can select one part from the plurality of parts of the first type based on a priority order. For example, the selection unit 250 can select one part of the first type such that the distance estimated for the selected part of the first type is longer than the distances estimated for the other ones of the plurality of parts of the first type. Specifically, the selection unit 250 can select a part of the first type such that the distance estimated by the distance estimation unit 240 is the smallest. In the present embodiment, the selection unit 250 selects the frame, among the two eye frames, that is closer to the nose. The eye indicated by the selected frame is in a position closer to the camera 100 than the other eye. The selection unit 250 can output information indicating the position of the selected part of the first type to the control unit 106.

The control unit 106 controls the image capture unit 101 such that the one part of the first type selected by the selection unit 250 is brought into focus. For example, the control unit 106 can perform AF processing such that the eye frame selected by the selection unit 250 is brought into focus.

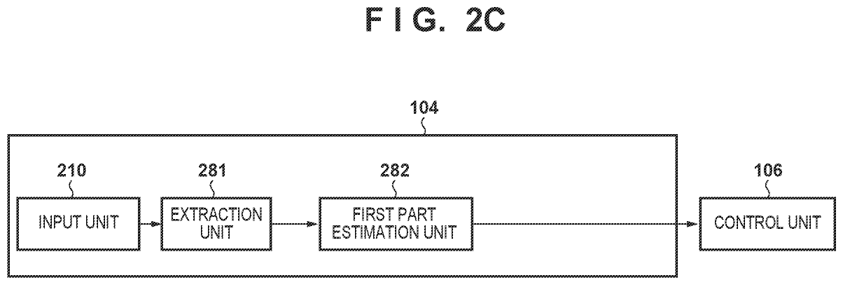

An example in which the image processing unit 104 detects an eye frame of interest from a moving image captured by the camera 100 will be described next. In this example, AF processing is performed with respect to the detected frame. FIG. 3 is a flowchart illustrating the flow of processing in an image processing method according to the embodiment. In the following descriptions, the letter S will be appended to the beginning of each process (step), and the word “step” will be omitted. However, the image processing unit 104 does not need to perform all of the steps illustrated in the flowchart.

In S300, the input unit 210 obtains one frame image from a time-series moving image captured by the image capture unit 101. The input unit 210 inputs the obtained image to the extraction unit 220. The input unit 210 may obtain a plurality of frame images in sequence. In that case, the processing illustrated in FIG. 3 is performed on each of the frame images. The image obtained in S300 is 8-bit RGB bitmap data, for example.

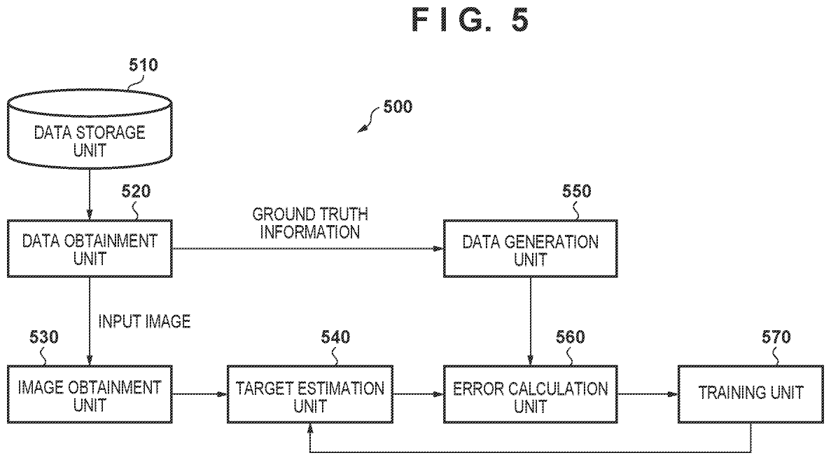

In S301, the extraction unit 220 extracts features of the image by processing the image obtained from the input unit 210. FIGS. 6A and 6B are schematic diagrams illustrating a relationship between the orientation of a face and a distance between an eye and a nose. FIG. 6A illustrates an input image 600 showing the face of a person who is looking to the right as seen from the camera. The eye that is closer to the camera (a right eye 601), the eye further from the camera (a left eye 602), and a nose 603 appear in the input image 600. FIG. 6B illustrates an input image 604 showing the face of the person facing forward. A right eye 605, a left eye 606, and a nose 607 appear in the input image 604.

As illustrated in FIG. 6B, when the person is facing the camera, the right eye 605 and the left eye 606 are approximately equidistant from the camera. The distance between the right eye and the nose (42) and the distance between the left eye and the nose (41) are about the same. On the other hand, as illustrated in FIG. 6A, when the person is looking to the right as seen from the camera, the distance between the right eye, which is closer to the camera, and the nose (49) is relatively long, and the distance between the left eye, which is further from the camera, and the nose (35) is relatively short. Thus, the distance between the eye that is closer to the camera and the nose is shorter than the distance between the eye that is further from the camera and the nose. In the present embodiment, this relationship is used to select the eye that is closer to the camera.

In S302, the first part estimation unit 230 detects an eye based on the features extracted by the extraction unit 220. The first part estimation unit 230 can detect one or two eyes. The first part estimation unit 230 can select a frame having a likelihood greater than a pre-set threshold. When detecting a plurality of such frames, the first part estimation unit 230 can select one or two frames in order from the higher likelihood.

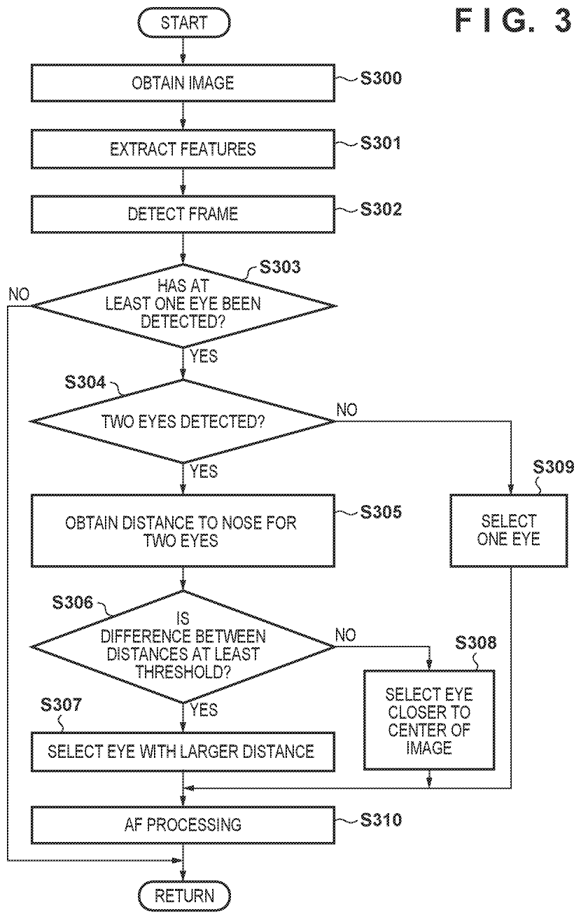

In the example described below, the extraction unit 220 is implemented with a trained model having trained parameters. This trained model can be implemented using a neural network, for example. The structure of the neural network used is not limited. FIG. 4 is a schematic diagram illustrating an example of a network structure implemented using a neural network and output results thereof. FIG. 4 illustrates an input image 400, eyes 401 and 402 of the person, and a nose 403 of the person. FIG. 4 also illustrates a center position map 404, which represents the magnitudes of likelihoods indicating the center positions of the eyes. The center position map 404 indicates likelihood magnitudes 405 and 406 for parts corresponding to the eyes 401 and 402 of the person in the image 400.

FIG. 4 also illustrates a size map 407, which represents eye widths. The size map 407 indicates width magnitudes 408 and 409 of the eyes 401 and 402 of the person in the image 400. FIG. 4 further illustrates a size map 410, which represents eye heights. The size map 410 indicates height magnitudes 411 and 412 of the eyes 401 and 402 of the person in the image 400. FIG. 4 also illustrates a distance map 413, which represents distances between the eyes and the nose. The distance map 413 indicates magnitudes 414 and 415 of the distances from the eyes to the nose of the person. A display result 416 indicates a result of displaying an eye frame 417 detected by the first part estimation unit 230 superimposed on the image 400. As will be described later, the frame 417 is selected by the selection unit 250 from a frame corresponding to the eye 401 and a frame corresponding to the eye 402.

The neural network illustrated in FIG. 4 has the network structure for facial organ detection described by Deng. In this network, the image 400 is input to a network 420 called a “backbone”. The network 420 then outputs intermediate features. The intermediate features output from the network 420 are input into networks 421 to 423 for corresponding tasks. FIG. 4 illustrates a network 421 for estimating eye positions, a network 422 for estimating eye sizes, and a network 423 for estimating distances between eyes and the nose. The network 421 outputs the center position map 404. The network 422 outputs two size maps 407 and 410. The network 423 outputs the distance map 413. In the present embodiment, each map 404, 407, 410, and 413 is a two-dimensional array, and is expressed as a grid.

In FIG. 4, the center position map 404 indicates that the likelihoods are higher closer to the center of the circle, and the likelihoods at the locations of the eyes is higher. The size maps 407 and 410 show results of inferring the widths and heights of the eyes provided that the respective positions are the center position of the eyes of the person. In FIG. 4, the length of the arrow represents the magnitude of the value. As illustrated in FIG. 4, positions corresponding to the center positions of the eyes in the size maps 407 and 410 indicate the inferred eye width and height values. The distance map 413 indicates results of inferring distances from positions to the nose, when each position is the center position of an eye of the person. In FIG. 4, the length of the arrow represents the magnitude of the value. As illustrated in FIG. 4, positions corresponding to the center positions of the eyes in the distance map 413 indicate the values of the inferred distances from those positions to the nose. In the example illustrated in FIG. 4, four maps are used to estimate the eye that is closer to the camera 100.

The frame indicating the eye region can be defined by the center coordinates, the width, and the height of a rectangle surrounding the eye. As described above, the center position map 404 expresses likelihoods indicating the center positions of the eyes. The first part estimation unit 230 selects elements having values exceeding a pre-set threshold in the center position map 404 as eye frame center position candidates. When elements selected as center position candidates are adjacent to each other, the first part estimation unit 230 can select the element having the higher likelihood as the center position of the eye. Note that the resolution of the center position map 404 may be lower than the resolution of the original image 400. In this case, the center position of the eye in the image 400 can be obtained by converting the center position of the eye in the center position map to a size matching that of the image 400. The first part estimation unit 230 also obtains the width and height of the eye frame from the elements of the size maps 407 and 410 corresponding to the center position of the eye detected. In this manner, the first part estimation unit 230 can determine the eye frame.

In S303, the selection unit 250 determines whether the first part estimation unit 230 has detected at least one eye. The sequence of FIG. 3 ends if it is determined that at least one eye has not been detected. However, the sequence moves to S304 if it is determined that at least one eye has been detected.

In S304, the selection unit 250 determines whether the first part estimation unit 230 has detected two eyes. The sequence moves to S309 if it is determined that two eyes have not been detected. In S309, the selection unit 250 selects the frame of the one eye detected in S302 as the AF region. However, the sequence moves to S305 if it is determined in S304 that two eyes have been detected.

In S305, the selection unit 250 estimates the distance between the eye and the nose for each of the two eyes detected in S302. Specifically, the selection unit 250 obtains the distance between the eye and the nose indicated in the distance map obtained in S301, corresponding to the center positions of the two eye frames. For example, the selection unit 250 can obtain the distance from each eye to the nose based on the elements of the distance map corresponding to the x coordinates and the y coordinates of the center positions of the frames of the two eyes obtained, determined in S302.

The selection unit 250 can select a method for selecting one of the two parts based on a difference in the distances between each of the two eyes and the nose. In S306, the selection unit 250 calculates the absolute value of the difference in the distance values for each of the two eyes obtained in S305. The selection unit 250 then determines whether the calculated absolute value is at least a set threshold. The sequence moves to S307 if the absolute value of the difference between the distances for the two eyes is determined to be at least the threshold. However, the sequence moves to S308 if the absolute value is determined to be less than the threshold.

The processing of S307 is performed when there is a large difference in the distances between each of the two eyes and the nose. In S307, one of the two eyes is selected according to a first method. Specifically, the selection unit 250 selects one of the two eyes based on a comparison of the distances between each of the two eyes and the nose. For example, the selection unit 250 selects one of the two eyes such that the distance between the selected eye and the nose is greater than the distance between the unselected eye and the nose. The selection unit 250 then selects the frame for the selected eye as the AF region.

The processing of S308 is performed when there is only a small difference in the distances between each of the two eyes and the nose, e.g., when the distances are approximately the same. In S308, one of the two eyes is selected according to a second method that is different from the first method. In this case, the distances from the camera to the two eyes are approximately the same, so it makes no significant difference which of the eyes is focused on. The selection unit 250 can therefore select one of the two eyes through any desired method. For example, the selection unit 250 may select the eye detected from a position closer to the center of the image. The selection unit 250 then selects the frame for the selected eye as the AF region.

In S310, the control unit 106 performs AF processing such that the one eye frame that is the AF region selected by the selection unit 250 is brought into focus. A phase difference detection method can be used as the AF processing method, for example.

### Training Method

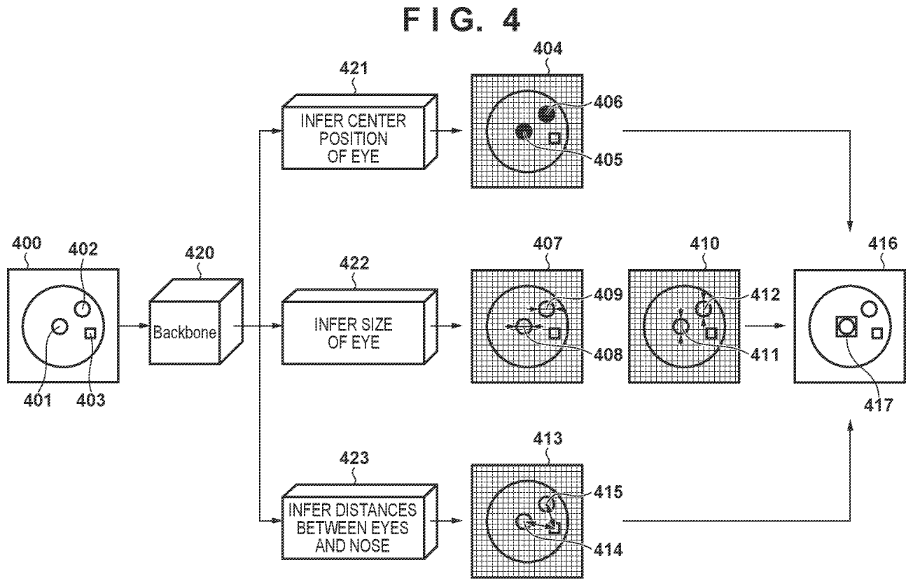

A neural network such as that illustrated in FIG. 4 can be trained as follows. FIG. 5 is a diagram illustrating the functional configuration of a training apparatus according to an embodiment. A training apparatus 500 trains the parameters of a trained model used by the image processing unit 104 to perform the processing described above. For example, the training apparatus 500 can generate the parameters of the trained model used by the extraction unit 220 in particular, and supply the parameters to the camera 100. The training apparatus 500 includes a data storage unit 510, a data obtainment unit 520, an image obtainment unit 530, a target estimation unit 540, a data generation unit 550, an error calculation unit 560, and a training unit 570.

The data storage unit 510 stores training data used for training. The training data used in the present embodiment includes a set of training images and ground truth information about eyes of people in the training images. The ground truth information in the present embodiment includes the coordinates of the center positions of the eyes, the sizes (widths and heights) of the eyes, and the distances between the eyes and the nose. The data storage unit 510 is assumed to store training data having sufficient amounts and variations for the training performed by the training apparatus 500. Note that the ground truth information may be information input by humans who have viewed the training images. The ground truth information may also be images obtained by an image processing apparatus performing detection processing on training images. The ground truth information need not be generated in real time. Therefore, such an image processing apparatus may generate the ground truth information using an algorithm that takes significant amounts of time and computational resources.

The data obtainment unit 520 obtains the training data stored in the data storage unit 510. The image obtainment unit 530 obtains the training images from the data obtainment unit 520. The images obtained by the image obtainment unit 530 are input to the target estimation unit 540. Note that the image obtainment unit 530 may perform data augmentation. For example, the image obtainment unit 530 can rotate, enlarge, reduce, and add noise to the image, or change the brightness or color of the image. Such data augmentation can be expected to make the processing performed by the image processing unit 104 more robust. When performing data augmentation involving geometric conversion, such as rotating, enlarging, or reducing an image, the image obtainment unit 530 can perform conversion processing in accordance with the geometric conversion on the ground truth information in the training data. The image obtainment unit 530 may input images obtained by such data augmentation to the target estimation unit 540.

The target estimation unit 540 performs processing equivalent to the extraction unit 220 provided in the image processing unit 104. In other words, the target estimation unit 540 can obtain a map, which indicates a distance to the second part for the part of the first type in the training images, obtained by inputting the training images into the trained model. In the present embodiment, the target estimation unit 540 outputs a center position map of the eyes of people in the training images, a size map of the eyes, and a distance map indicating the distance between the eyes and the nose, based on the training images input by the image obtainment unit 530. In the present embodiment, the target estimation unit 540 can generate these maps using the trained model. For example, the target estimation unit 540 can generate the maps using the neural network illustrated in FIG. 4.

The data generation unit 550 generates supervisory data based on the ground truth information obtained from the data obtainment unit 520. This supervisory data is used as target values for the output of the target estimation unit 540. For example, the data generation unit 550 can generate a center position ground truth map for the eyes, a size ground truth map for the eyes, and a ground truth map for the distance between the eyes and the nose, as the supervisory data.

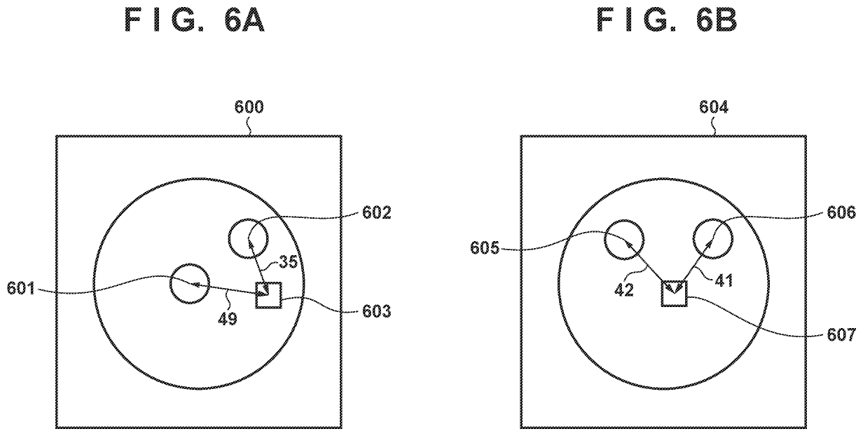

FIGS. 7A to 7E are schematic diagrams illustrating a training image, ground truth information, and a center position ground truth map for an eye. FIG. 7A illustrates a training image 700 in which a person's face appears. FIG. 7B illustrates ground truth information 710 for the training image 700. FIG. 7C illustrates ground truth information 720 expressed as coordinates in a ground truth map. FIG. 7A further illustrates an enlarged view 730 of the area near the person's eye in the center position ground truth map for the eye. FIG. 7D illustrates an enlarged view of the area near the person's eye in the size ground truth map 740 for the eye. FIG. 7E illustrates an enlarged view of the area near the person's eye in the ground truth map 750 for the distance between the eye and the nose.

In the example illustrated in FIGS. 7A to 7E, the training image 700 in which the person appears and the ground truth information illustrated in FIG. 7B are provided as the training data. The ground truth information includes center coordinates of the person's eye (X,Y), namely (900,300), the size of the eye (20), and the distance between the eye and the nose (85). The center coordinates of the eye, the size of the eye, and the distance between the eye and the nose in FIG. 7B are indicated by the coordinates, the size, and the distance in the training image 700. In this example, the size of the training image 700 (and the image obtained by the input unit 210) is 1,600×1,200 pixels. The distance is the Euclidean distance between the eye and the nose. However, the distance may be another type of distance, such as a Manhattan distance or a Chebyshev distance. Note also that the ground truth information may include position and size information for two or more eyes. In this case, the position or region corresponding to each eye in each map can be labeled.

Furthermore, in the example in FIGS. 7A to 7E, the supervisory data indicates an absolute distance between the eye and the nose. However, the supervisory data may indicate a relative distance instead. The relative distance between one eye and the nose represents a relative value of the distance between one eye and the nose relative to the distance between the other eye and the nose. For example, if two eyes of a single person appear in the training image 700, an average value for the distance between the eye and the nose can be calculated for each eye. The relative distance for each eye can then be calculated by subtracting the average value from the distance for each eye. In this case, the relative distance takes on a positive value when the distance is relatively long. Conversely, the relative distance takes on a negative value when the distance is relatively short. The relative distance is near 0 when the distances are approximately the same. The distance indicated by the supervisory data may also be a normalized value. For example, the distance can be normalized by dividing the absolute distance by the size of the face. When training using such supervisory data, the image processing unit 104 can generate a distance map indicating a relative distance or a normalized absolute distance. The distance estimation unit 240 can estimate the distance using a trained model trained using such a distance map. In other words, the distance between the part of the first type and the second part estimated by the distance estimation unit 240 may be a relative distance which is relative to the distance between another part of the first type and the second part. The distance between the part of the first type and the second part estimated by the distance estimation unit 240 may also be a normalized distance.

Note that when only one eye appears in the training image 700 for a single person, the distance indicated by the supervisory data for the eye may be a positive value obtained by multiplying the face size by a constant multiple. For example, if the size of the face in the image is 240, the supervisory data may indicate a value of 72, obtained by multiplying 240 by 0.3. The distance indicated by the supervisory data may also be a positive constant independent of the face size. Furthermore, the training may be controlled so as not to perform the training uniformly using a training image 700 in which only one eye appears for a single person.

The center position ground truth map for the eye is matrix-form data having the same size as the center position map of the eye output by the target estimation unit 540. In the present embodiment, the size of the center position ground truth map is 320×240. In this manner, the center position ground truth map has a size ⅕ that of the training image on both the vertical and the horizontal. In this example, the size ground truth map and the distance ground truth map also have the same size as the center position ground truth map. Accordingly, to obtain the ground truth information 720 expressed as coordinates in the ground truth map illustrated in FIG. 7C, a value indicating the center coordinates of the eye and the size of the eye in the training images is set to ⅕. In the example in FIG. 7C, the center coordinates of the eye are (X,Y)=(180,60), and the size of the eye is 4.

A center position ground truth map 730 of the eye is a map obtained by labeling positive cases at the center position of the eye. As illustrated in FIG. 7A, in the center position ground truth map 730, a heat map of a circular region, which is centered on the coordinates (X,Y)=(180,60) and which has a diameter corresponding to the size of the eye (4), is assigned as a label. In this example, the ground truth map has values in a range of 0 to 1. The center of the circular region therefore has a maximum value of 1. The value also gradually decreases with proximity to the edges of the circular region.

A size ground truth map 740 of the eye is a map obtained by labeling positive cases in the eye region. As illustrated in FIG. 7D, in the size ground truth map 740, a label is assigned in a frame which is centered on the center coordinates of the eye (X,Y)=(180,60) and in which the length of one side is the same as the size of the eye. The black bold frame in the size ground truth map 740 indicates the center position of the eye. The value of the label can be determined according to the size of the eye. For example, as illustrated in FIG. 7D, a value (0.1) obtained by dividing the eye size (20) by a maximum size (200) can be used as the value of the label. Empty values can also be assigned to the elements outside the frame so that such elements do not contribute to the training.

A distance ground truth map 750 is a map obtained by labeling positive cases in the eye region. In the distance ground truth map 750, information indicating a distance between the part of the first type (the eye, in this example) and the second part (the nose, in this example) is assigned to the position corresponding to the part of the first type in the training image. As illustrated in FIG. 7E, in the distance ground truth map 750, a label is assigned in a frame which is centered on the center coordinates of the eye (X,Y)=(180,60) and in which the length of one side is the same as the size of the eye. The black bold frame in the distance ground truth map 750 indicates the center position of the eye. The value of the label can be determined according to the distance between the eye and the nose. For example, as illustrated in FIG. 7E, a value (0.2) obtained by dividing the distance (85) by a maximum size (425) can be used as the value of the label. Empty values can also be assigned to the elements outside the frame so that such elements do not contribute to the training.

The error calculation unit 560 calculates a center position error, which is error between the center position map of the eye output by the target estimation unit 540 and the center position ground truth map of the eye generated by the data generation unit 550. The error calculation unit 560 also calculates a size error, which is error between the size map of the eye output by the target estimation unit 540 and the size ground truth map of the eye generated by the data generation unit 550. The error calculation unit 560 furthermore calculates a distance error, which is error between the distance map output by the target estimation unit 540 and the distance ground truth map generated by the data generation unit 550.

The training unit 570 updates the parameters of the trained model used by the target estimation unit 540 based on the error calculated by the error calculation unit 560. For example, the training unit 570 can update the parameters of the trained model so as to reduce the center position error, the size error, and the distance error. The method for updating the parameters is not particularly limited. The training unit 570 can update the parameters of the trained model used by the target estimation unit 540 through error back-propagation, for example. In this manner, the training unit 570 can train the parameters of the trained model based on a map, obtained by the target estimation unit 540, which indicates a distance to the second part for the part of the first type in the training image, and the distance ground truth map.

The parameters to be used by the target estimation unit 540, updated by such training, are supplied to the camera 100. The image processing unit 104 can then estimate the center position of the eye, the size of the eye, and the distance by performing processing according to the supplied parameters. For example, the extraction unit 220 can generate a center position map, a size map, and a distance map by performing processing using a neural network according to the supplied parameters.

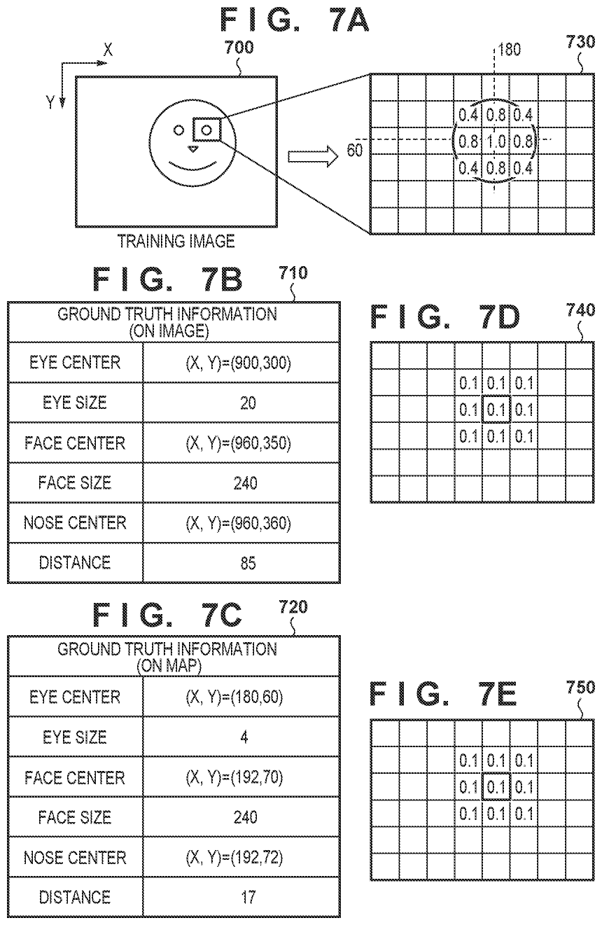

FIG. 8 is a flowchart illustrating the flow of processing in a training method according to an embodiment. According to this method, a trained model having parameters trained to be used to estimate the distance between the part of the first type and a second part in the image can be produced.

In S801, the data obtainment unit 520 obtains the training data stored in the data storage unit 510. In S802, the image obtainment unit 530 obtains the training images from the data obtainment unit 520.

In S803, the target estimation unit 540 performs inference processing on the training images obtained from the image obtainment unit 530. The target estimation unit 540 can output the center position map of the eye, the size map of the eye, and a distance map of the distance between the eye and the nose. In S804, the data generation unit 550 generates the center position ground truth map of the eye, the size ground truth map of the eye, and the ground truth map for the distance between the eye and the nose, according to the method described above, from the ground truth information obtained in S801.

In S805, the error calculation unit 560 calculates the center position error based on the center position ground truth map of the eye generated in S804 and the center position map of the eye obtained in S803. The error calculation unit 560 also calculates the size error based on the size ground truth map of the eye generated in S804 and the size map of the eye obtained in S803. The error calculation unit 560 furthermore calculates the distance error based on the distance ground truth map generated in S804 and the distance map obtained in S803.

In S806, the training unit 570 trains the parameters used by the target estimation unit 540 so as to reduce the center position error, the size error, and the distance error calculated in S805. In step S807, the training unit 570 determines whether to continue the training. If the training is to be continued, the processing of S801 and thereafter is repeated. If the training is not to be continued, the processing illustrated in FIG. 8 ends. The method for determining whether to continue the training is not particularly limited. For example, whether to continue the training can be determined based on whether the number of instances of training has reached a predetermined number, or whether the training time has reached a predetermined length of time. The processing illustrated in FIG. 8 can be repeated using a variety of pieces of training data.

In the foregoing embodiment, the eye, among a plurality of eyes, which is closer to the camera 100 is detected based on the distance between the eye and the nose. However, the detection target (the part of the first type) is not limited to an eye. For example, the detection target may be a part of which there are a plurality on the face, such as an ear. If the detection target is an ear, the selection unit 250 may select one of the two ears detected by the first part estimation unit 230 based on the distances between the ears and the nose. For example, the selection unit 250 can select the one of the two ears that is further away from the nose in the image. The ear selected in this manner is in a position closer to the camera 100 than the other ear.

In addition, in the foregoing embodiment, one eye is selected based on the distances between the eyes and the nose. However, the distances used by the selection unit 250 is not limited to the distances between the eyes and the nose. For example, another second part can be used instead of the nose. The second part may be a part that is equidistant from both eyes when the face is facing forward, for example. In the present specification, “equidistant from both eyes” includes being substantially equidistant from both eyes. For example, the second part may be a part on a center line extending vertically along the face. The mouth, chin, the top of the head, the brow, and the like can be given as specific examples of the second part. The selection unit 250 can select the eye that is further from that part based on the distance between that part and the eye. The subject is also not limited to a person. If the subject is a bird, the distance between the eye and the tip of the beak can be used in a similar manner to select the eye that is closer to the camera 100.

Furthermore, in the foregoing embodiment, if it is determined in S306 that the difference in the distances for the two eyes is less than a threshold, the eye that is closer to the center of the image is selected in S308. However, tracking processing that tracks a subject in a moving image may be used. In this case, in S308, the selection unit 250 can select the eye that is closer to the coordinates of the eye tracked in the previous frame. For example, one of the two eyes may be selected based on the result of tracking an eye in a past frame. The selection unit 250 may have selected one part of the first type from a plurality of parts of the first type (eyes, in this example) detected from a past image captured before the current image. In this case, in S308, the selection unit 250 can select one of the two parts of the first types based on the position of one part of the first type selected from the plurality of parts of the first type detected from the past image. For example, the selection unit 250 can select one eye, among the two eyes, that is closer to the one eye selected from the plurality of eyes detected from the past image. The selection unit 250 may also select the larger eye in S308.

Additionally, in the foregoing embodiment, when at least one eye is detected, AF processing for focusing on the eye is performed in accordance with the determination in S303. However, if at least one eye is not detected, AF processing for focusing on a part different from the eye may be performed. For example, the extraction unit 220 may detect a face frame, a head frame, or a full body frame from an image. In this case, the extraction unit 220 may perform AF processing that preferentially focuses on smaller frames.

The foregoing example assumes that one person is present in the image. As such, in S304, it is determined whether two eyes have been detected. If more than one person is present, three or more eyes may be detected. However, the eye that is closer to the camera can be selected using a similar method in this case as well. For example, the first part estimation unit 230 may detect a third part in the image. The third part may be a face, a head, or a person, for example. The first part estimation unit 230 can also determine a frame corresponding to the third part, such as a face frame, a head frame, or a person region. Such a determination can be performed using the features of the image extracted by the extraction unit 220.

In this case, the first part estimation unit 230 can detect the part of the first type from inside the detected frame. For example, the first part estimation unit 230 can detect only eyes included in a face frame, a head frame, or a person region. The first part estimation unit 230 may also detect only two eyes included in a specific single face frame, head frame, or person region. The specific single face frame, head frame, or person region may be the largest face frame, head frame, or person region in the image. According to this method, when an eye is detected for a plurality of people, the selection target can be limited to two eyes of the same single person.

In the present embodiment, the eye, among the plurality of eyes, that is closer to the camera is selected preferentially. However, the priority order is not limited thereto. The eye that is further from the camera may be selected preferentially, for example. The eyes included in the face frame may also be selected preferentially.

As described above, according to the present embodiment, the part of the first type (e.g., the eye) closer to the image capturing apparatus is selected based on the distance between the part of the first type and the second part (e.g., the nose). According to the method of the present embodiment, the number of parts required for detection can be reduced as compared to a case where the posture of the subject (e.g., the orientation of the face) is estimated. As such, the part of the first type that is closer to the image capturing apparatus can be detected quickly. The cost of preparing the ground truth data used in the training for detecting the respective parts can also be reduced.

In particular, in the present embodiment, a trained model is used to estimate the distance between the part of the first type and the second part. In such a configuration, the distance between the eye and the nose can be estimated based on information of other parts of the face (e.g., parts around the eye), even if the nose is hidden, for example. This improves the accuracy and robustness of the processing for detecting the eye that is closer to the image capturing apparatus.

According to a method that detects the eye that is closer to the image capturing apparatus based on the distances between the eyes and the nose (or another second part), as in the present embodiment, the detection accuracy is improved as compared to a method that selects an eye using only information pertaining to the eye (e.g., the size of the eye). The method of the present embodiment improves the detection accuracy particularly in cases where the eye is partially hidden.

Additionally, detecting the eye that is closer to the image capturing apparatus and focusing on the detected eye as in the present embodiment makes it possible to shoot headshots that leave an impression. In other words, the configuration of the present embodiment makes it possible to shoot a headshot that is more impressive than when focusing on the largest eye in the image (e.g., the eye that is open wider) to improve the focus accuracy. Additionally, the configuration of the present embodiment makes it possible to shoot a headshot that is more impressive than when focusing on the part that has the highest likelihood of indicating an eye in the image.

### First Variation

The method of estimating the distance between the part of the first type (e.g., the eye) and the second part (e.g., the nose) in the image is not limited to the foregoing method. For example, the second part in the image may be detected instead of using a distance map as described above. The distance between the part of the first type and the second part can be calculated in accordance with the result of such a detection. In the following variation, in addition to the part of the first type, the center coordinates of the second part are estimated as well. Then, the distance between the part of the first type and the second part is calculated based on the center coordinates of the part of the first type and the second part that have been estimated. A part of the first type to be prioritized is then selected based on the calculated distance. The following descriptions will assume that the part of the first type is the eye of a person and the second part is the nose.

FIG. 2B illustrates the functional configuration of the image processing unit 104, which is an image processing apparatus according to the present variation. In the present variation, the image processing unit 104 includes an extraction unit 271 instead of the extraction unit 220. Additionally, the image processing unit 104 includes a distance calculation unit 273 instead of the distance estimation unit 240. The image processing unit 104 furthermore includes a second part estimation unit 272. The other configurations are the same as those illustrated in FIG. 2A, and will therefore not be described in detail.

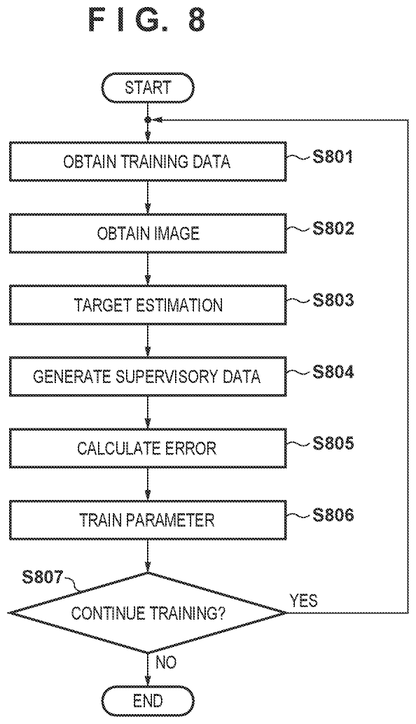

Like the extraction unit 220, the extraction unit 271 extracts features from the image obtained by the input unit 210. FIG. 9 illustrates an example of the structure of a neural network used in the present variation. The neural network illustrated in FIG. 9 outputs a center position map 918 indicating the center position of the nose, in addition to a center position map 904 indicating the center position of the eye and the two size maps 907 and 910 indicating the width and height of a frame surrounding the eye. 900 to 912, 916 to 917, and 920 to 922 in FIG. 9 correspond to 401 to 412, 416 to 417, and 420 to 422 in FIG. 4. A feature output from a network 920 is input into a network 923. The network 923 then outputs the center position map 918. The center position map 918 indicates a magnitude 919 of the likelihood of being the nose of the person. Like the center position map 904 of the eye, the center position map 918 of the nose indicates that the likelihoods increase with proximity to the center of the circle, and the likelihood at the location of the nose is high. The extraction unit 271 can extract the feature through processing that uses a neural network such as that illustrated in FIG. 9.

The second part estimation unit 272 detects a second part in an image. For example, the second part estimation unit 272 can determine the position of the second part based on a likelihood of the second part at each of positions in the image. The second part estimation unit 272 can detect the second part based on the features of the image extracted by the extraction unit 271. For example, the second part estimation unit 272 can select, as the center position of the nose, a single position having a high likelihood in the center position map of the nose output by the extraction unit 271. This processing can be performed in the same manner as the first part estimation unit 230. If the first part estimation unit 230 detects the part of the first type from inside a predetermined frame (e.g., a face frame) as described above, the second part estimation unit 272 may detect the second part from inside the same frame.

The distance calculation unit 273 determines a distance between the part of the first type detected from the image by the first part estimation unit 230 and the second part detected from the image by the second part estimation unit 272. For example, the distance calculation unit 273 can calculate a distance between each of (i) the center positions of the two eye frames detected by the first part estimation unit 230 and (ii) the position of the nose detected by the second part estimation unit 272. This distance may be a Euclidean distance, or may be another type of distance.

The image processing method according to the present variation can be performed in accordance with the flowchart illustrated in FIG. 3. In the present variation, processing such as the following is performed in S305. First, the second part estimation unit 272 estimates the center position of the nose as described above. Furthermore, the distance calculation unit 273 calculates the distance between the eye and the nose for each of the two eyes detected in S302, as described above. For example, the distance calculation unit 273 can calculate the Euclidean distance between the coordinates (x and y coordinates) of the center position of the frame obtained in S302 and the coordinates (x and y coordinates) of the estimated center position of the nose.

Assume a case where the distance between one eye and the nose is 49 and the distance between the other eye and the nose is 33 in this variation. In this case, the difference between the two distances is 16. If the threshold used in S306 is 15, the difference is greater than the threshold, and the processing therefore moves to S307. In this case, in S307, the eye that is further away from the nose, which in this example is the eye at a distance of 49 from the nose, is selected.

A training method for a neural network such as that illustrated in FIG. 9 will be described next. The training processing can be performed using the training apparatus 500 illustrated in FIG. 5. Detailed descriptions of configurations already described will not be given. In the case of the present variation, the target estimation unit 540 performs processing equivalent to that of the extraction unit 271. In other words, the target estimation unit 540 can output a center position map of the eyes of people in the training images, a size map of the eyes, and a center position map of the nose.

The data generation unit 550 generates the center position ground truth map of the eye, the size ground truth map of the eye, and the center position ground truth map of the nose as the supervisory data. A case in which the training image 700 in which a person appears and the ground truth information illustrated in FIG. 7B are used as the training data will be described here as an example. The ground truth information indicates the center coordinates of the nose (X,Y)=(960,360), which are coordinates in the training image 700. The center position ground truth map of the nose (not shown), which is the supervisory data for the center position of the nose, is matrix data having the same size as the center position map of the nose output by the target estimation unit 540. In this example, the size of the center position ground truth map of the nose is 320×240, and has a size ⅕ that of the training image on both the vertical and the horizontal. Accordingly, to obtain the ground truth information 720 expressed as coordinates in the ground truth map illustrated in FIG. 7C, a value indicating the center coordinates of the eye and the size of the eye in the training images is set to ⅕. In the example in FIG. 7C, the center coordinates of the nose are (X,Y)=(192,72). The center position ground truth map of the nose can be created in the same manner as the center position ground truth map 730 of the eye, in accordance with the center coordinates of the nose.

The error calculation unit 560 calculates the center position error for the eye and the size error for the eye as described above. Furthermore, the error calculation unit 560 calculates a center position error for the nose, which is error between the center position map of the nose output by the target estimation unit 540 and the center position ground truth map of the nose generated by the data generation unit 550. The training unit 570 can update the parameters used by the target estimation unit 540 based on the error calculated by the error calculation unit 560 in this manner.

The training method according to the present variation can be performed in accordance with the flowchart illustrated in FIG. 8. In the present variation, in S803, the target estimation unit 540 outputs the center position map of the eye, the size map of the eye, and the center position map of the nose through inference processing on the training image obtained from the image obtainment unit 530. In S804, the data generation unit 550 generates the center position ground truth map of the eye, the size ground truth map of the eye, and the center position ground truth map of the nose, according to the method described above, from the ground truth information obtained in S801. In S805, the error calculation unit 560 calculates the center position error of the eye, the size error of the eye, and the center position error of the nose, as described above. The other processing can be performed as described earlier.

As described above, according to the present variation, the distance between the part of the first type (e.g., the eye) and the second part (e.g., the nose) is calculated directly. This configuration is expected to improve the accuracy of detecting the part of the first type that is closer to the image capturing apparatus when the second part is clearly visible.

### Second Variation

In the present variation, the part of the first type that is closer to the camera is detected directly. FIG. 2C illustrates the functional configuration of the image processing unit 104, which is an image processing apparatus according to the present variation. In the present variation, the image processing unit 104 includes an extraction unit 281 and a first part estimation unit 282 in addition to the input unit 210. The functions of the input unit 210 are as described earlier.

Like the extraction unit 220, the extraction unit 281 extracts features from the image obtained by the input unit 210. The first part estimation unit 282 detects a closer part, which is a first type part (e.g., an eye) in the image and which is a part closer to the image capturing apparatus that captured the image than other part of the first types in the image. The first part estimation unit 282 can detect the closer part based on the features of the image extracted by the extraction unit 281. For example, the extraction unit 281 can generate a center position map indicating a center position of the eye that is closer to the camera. The first part estimation unit 282 can select one frame according to the likelihoods indicated by the center position map. As described earlier, the extraction unit 281 can also generate two size maps indicating the width and height of the frame surrounding the eye. The first part estimation unit 282 then outputs information indicating the detection result.

The first part estimation unit 282 can detect the closer part using a trained model trained to estimate the closer part in the image. In the present variation, the extraction unit 281 is implemented as a trained model having trained parameters. In one embodiment, the center position of the second part (e.g., the nose) or the distance between the part of the first type and the second part is used when generating the supervisory data used for training the parameters. According to such a configuration, the first part estimation unit 282 can estimate the eye that is closer to the camera with a higher level of accuracy.

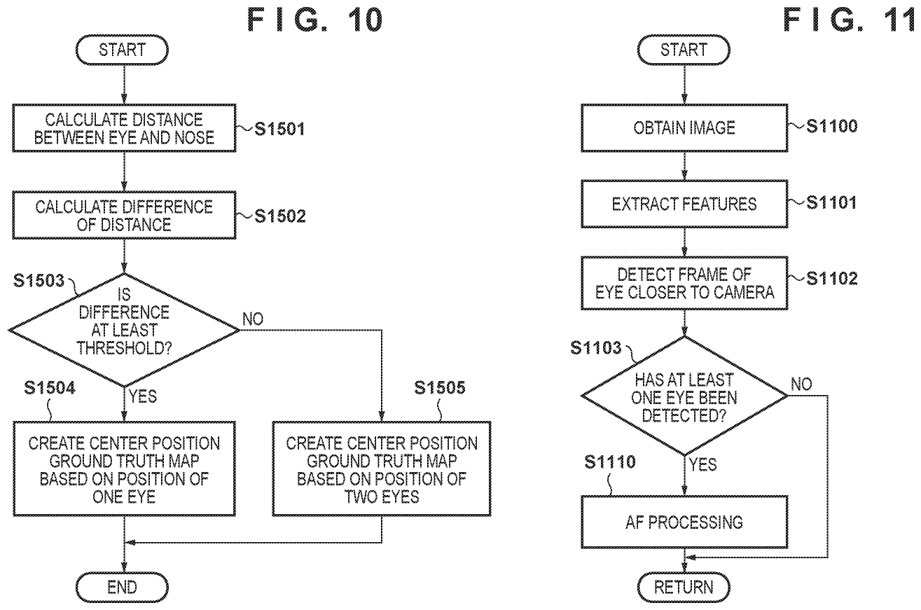

FIG. 11 is a flowchart illustrating the flow of processing in the image processing method according to the present variation. S1100 and S1110 correspond to S300 and S310. In S1101, the extraction unit 281 extracts features from the image obtained in S1100. In this example, the extraction unit 281 outputs a center position map of the eye, indicating a center position of the eye that is closer to the camera, and a size map of the eye that is closer to the camera, as the features. The center position map of the eye in the present variation indicates the likelihood that the closer part is present for the image.

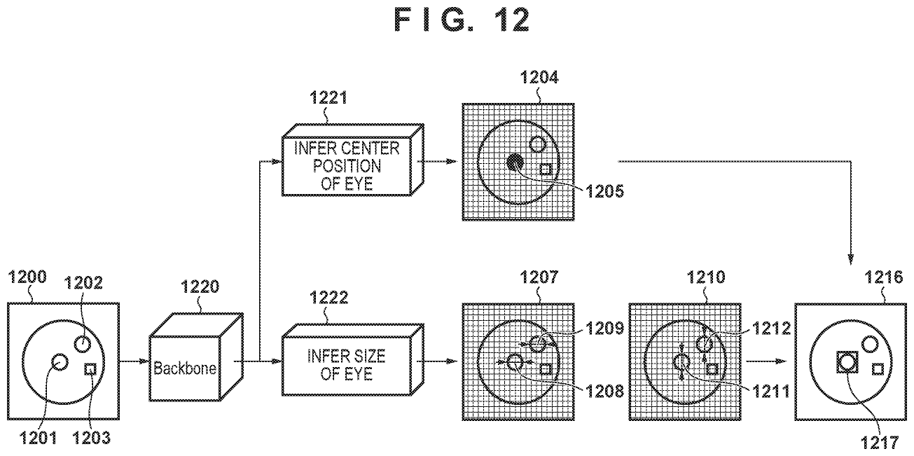

FIG. 12 illustrates an example of the structure of a neural network used in the present variation. The neural network illustrated in FIG. 12 outputs a center position map indicating the center position of the eye that is closer to the camera, and two size maps indicating the width and the height of the frame surrounding the eye. 1207 to 1211, 1216, 1217, 1220, and 1222 in FIG. 12 correspond to 407 to 411, 416, 417, 420, and 422 in FIG. 4. FIG. 12 illustrates an input image 1200. A person's eye 1201, which is closer to the camera, the person's eye 1202, which is further from the camera, and the person's nose 1203 appear in the input image 1200. A feature output from a network 1220 is input into a network 1221. The network 1221 then outputs a center position map 1204 indicating a center position of the person's eye that is closer to the camera, as illustrated in FIG. 12. FIG. 12 indicates a magnitude 1205 of the likelihood of being the person's eye that is closer to the camera. Like the center position map 904, the center position map 1204 indicates that the likelihood increases with proximity to the center of the circle, and the likelihood is highest at the location of the person's eye that is closer to the camera. The extraction unit 281 can extract the feature through processing that uses a neural network such as that illustrated in FIG. 12.

In S1102, the first part estimation unit 282 selects one eye frame based on the likelihood indicated by the center position map of the eye. For example, the first part estimation unit 282 can select the eye frame such that the frame has the highest likelihood and the likelihood also exceeds a pre-set threshold. This processing can be performed in the same manner as that of the first part estimation unit 230, except that only one eye frame is selected.

In S1103, the control unit 106 determines whether at least one eye has been detected. The sequence of FIG. 11 ends if it is determined that at least one eye has not been detected. However, if it is determined that at least one eye has been detected, in S1110, the control unit 106 performs AF processing on the frame of the one eye selected by the first part estimation unit 282.

### Training Method

A training method for a neural network such as that illustrated in FIG. 12 will be described next. The training processing can be performed using the training apparatus 500 illustrated in FIG. 5. Detailed descriptions of configurations already described will not be given. In the case of the present variation, the target estimation unit 540 performs processing equivalent to that of the extraction unit 281. In other words, the target estimation unit 540 can obtain a size map of the eye that is closer to the camera, which indicates the likelihood, obtained by inputting training images into the trained model, that there is a part closer to the image capturing apparatus that captured the image than other parts of the first type in the training images. In the present embodiment, the target estimation unit 540 can output a center position map indicating the center position of the eye that is closer to the camera in the training image, and a size map of the person's eye that is closer to the camera.

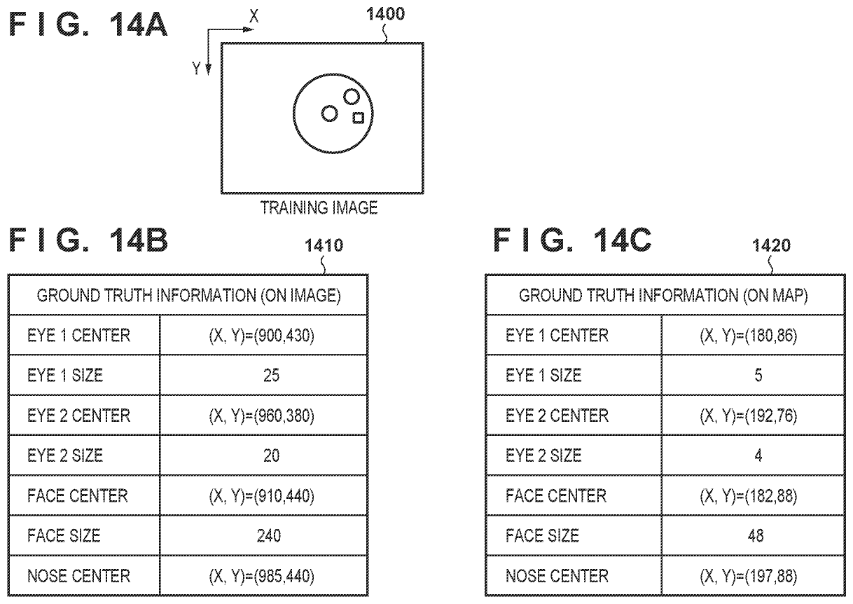

FIGS. 14A to 14C are schematic diagrams illustrating training images and ground truth information. FIG. 14A illustrates a training image 1400 in which a person's face appears. FIG. 14B illustrates ground truth information 1410 for the training image 1400. The information indicated by the ground truth information 1410 is based on coordinates in the training image 1400. FIG. 14C illustrates ground truth information 1420 expressed as coordinates in a ground truth map. The training data used for training in this example includes the training image 1400 and the ground truth information 1410. The ground truth information 1410 indicates the center coordinates of a first eye (eye 1) of the person (X,Y)=(900,380), the size of the first eye (25), the center coordinates of a second eye (eye 2) of the person (X,Y)=(960,340), and the size of the second eye (20). The ground truth information 1410 further indicates the center coordinates of the person's face (X,Y)=(910,440), the size of the face (240), and the center coordinates of the nose (985,440). Here, the center coordinates of the first eye, the center coordinates of the second eye, the center coordinates of the face, and the center coordinates of the nose are indicated as coordinates in the training image 1400. The size of the first eye, the size of the second eye, and the size of the face also indicate sizes in the training image 1400.

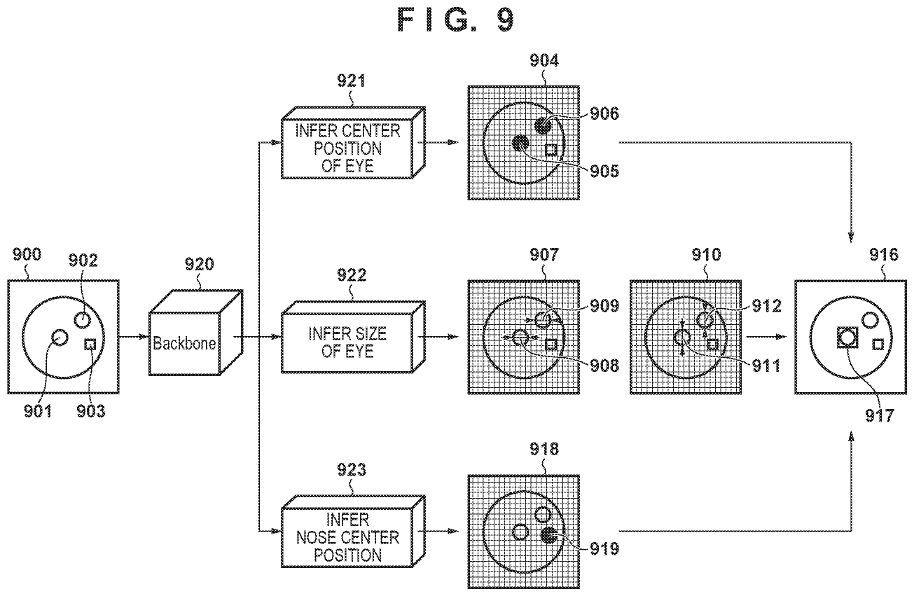

The data generation unit 550 generates supervisory data based on the ground truth information obtained from the data obtainment unit 520. This supervisory data is used as target values for the output of the target estimation unit 540. In this example, the data generation unit 550 can generate the center position ground truth map of the eye that is closer to the camera, and the size ground truth map of the eye that is closer to the camera, as the supervisory data. The specific generation method will be described later with reference to FIG. 10.

The training method according to the present variation can be performed in accordance with the flowchart illustrated in FIG. 8. According to this method, a trained model having parameters trained to be used to estimate the position of a part of the first type in the image, which is a part closer to the image capturing apparatus that captured the image than other parts of the first type in the image, can be produced.

In the present variation, in S803, the target estimation unit 540 outputs the center position map of the eye that is closer to the camera and the size map of the eye that is closer to the camera through inference processing on the training image obtained from the image obtainment unit 530. In S804, the data generation unit 550 generates the center position ground truth map of the eye that is closer to the camera and the size ground truth map of the eye that is closer to the camera from the ground truth information obtained in S801. The ground truth information indicates a distance between each of a plurality of parts of the first type (the eye, in this example) and the second part (the nose, in this example) in the training image. The data generation unit 550 can generate the center position ground truth map based on such a distance.

The processing of S804 in the present variation can be performed in accordance with the flowchart illustrated in FIG. 10. FIG. 10 illustrates the flow of the supervisory data generation processing. In S1501, the data generation unit 550 calculates a first distance between the center coordinates of the first eye and the center coordinates of the nose. The data generation unit 550 also calculates a second distance between the center coordinates of the second eye and the center coordinates of the nose. In the example illustrated in FIG. 14B, the first distance is (86) and the second distance is (65). In this example, Euclidean distances are used for the first and second distances. However, another type of distance may be used. For example, the first and second distances may be normalized distances normalized by dividing by a value such as the image size.

In S1502, the data generation unit 550 calculates a difference between the first distance and the second distance. In the example illustrated in FIG. 14B, the first distance is greater than the second distance, and the absolute value of the difference is (21).

In S1503, the data generation unit 550 determines whether the absolute value of the difference between the distances calculated in S1502 is at least a threshold. In this example, (10) is used as the threshold. If it is determined that the absolute value of the distance difference is at least the threshold, the sequence moves to S1504. However, if it is determined that the absolute value of the distance difference is less than the threshold, the sequence moves to S1505.

In S1504, the data generation unit 550 selects one part from the plurality of parts of the first type (the eye, in this example) in the training image. The distance between the selected part and the second part (the nose, in this example) is greater than the distance between the other part of the first type and the second part. For example, the data generation unit 550 can select the one of the two eyes that is closer to the nose. In the example illustrated in FIG. 14B, the first distance is greater than the second distance, and the first eye is therefore selected. The data generation unit 550 then generates a center position ground truth map of the eye that is closer to the camera based on the position of the selected eye. The data generation unit 550 can obtain a ground truth map in which the position corresponding to the selected part is labeled. For example, the data generation unit 550 can assign a label to the position corresponding to the first eye in the center position ground truth map.

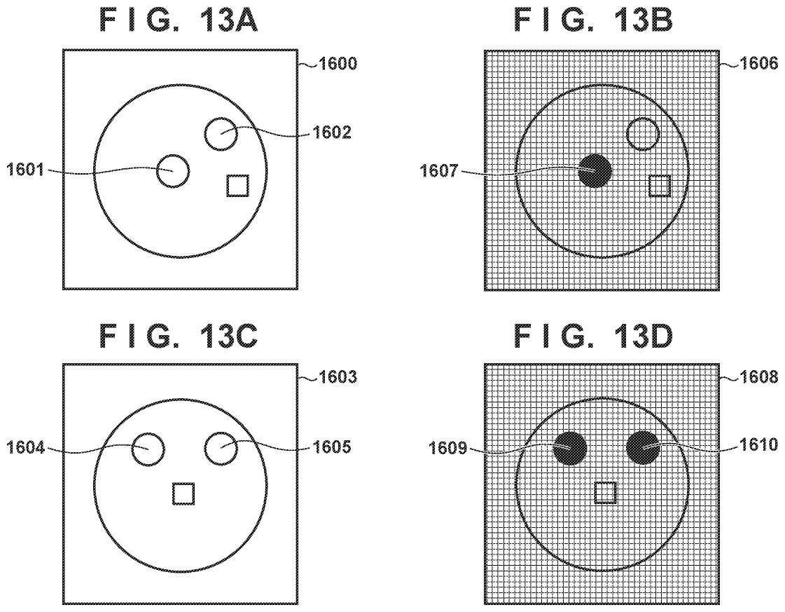

FIGS. 13B and 13D are schematic diagrams illustrating the center position ground truth map of the eye that is closer to the camera. FIG. 13A illustrates a training image 1600 in which the face of a person facing to the right is present. An eye 1601 closer to the camera and an eye 1602 further from the camera appear in the training image 1600. FIG. 13B also illustrates a center position ground truth map 1606 of the eye that is closer to the camera, and a magnitude 1607 of the likelihood of being the eye that is closer to the camera, corresponding to the training image 1600. The processing of S1504 is performed when the face of a person facing to the right is present in the training image. In this case, only the positions corresponding to the selected one eye are labeled in the center position ground truth map 1606 corresponding to the training image 1600, as illustrated in FIG. 13B.

In S1505, the data generation unit 550 generates the center position ground truth map of the eye that is closer to the camera based on the respective positions of the two eyes. In this example, the data generation unit 550 can assign labels to the positions corresponding to the first and second eyes in the center position ground truth map.

FIG. 13C illustrates a training image 1603 in which the face of a person facing forward is present. Eyes 1604 and 1605, which are about the same distance from the camera, appear in the training image 1600. FIG. 13D also illustrates a center position ground truth map 1608 of the eye that is closer to the camera, and magnitudes 1609 and 1610 of the likelihood of being the eye that is closer to the camera, corresponding to the training image 1603. The processing of S1505 is performed when the face of a person facing forward is present in the training image. In this case, the positions corresponding to the two eyes are labeled in the center position ground truth map 1608 corresponding to the training image 1603, as illustrated in FIG. 13D.

The method for assigning labels in S1504 and S1505 is the same as the method for assigning the labels to the center position ground truth map 730 of the eye illustrated in FIG. 7A, and will therefore not be described.

Note that the data generation unit 550 also generates the size ground truth map of the eye that is closer to the camera in S804. The method for generating the size ground truth map is the same as that described earlier. For example, in S1504, the data generation unit 550 can assign a label to the region corresponding to the selected one eye in the size ground truth map. In addition, in S1505, the data generation unit 550 can assign a label to the region corresponding to each of the two detected eyes in the size ground truth map.

In S805, the error calculation unit 560 calculates the center position error based on the center position ground truth map of the eye that is closer to the camera, generated in S804, and the center position map of the eye that is closer to the camera, obtained in S803. The error calculation unit 560 also calculates the size error based on the size ground truth map of the eye that is closer to the camera, generated in S804, and the size map of the eye that is closer to the camera, obtained in S803. In S806, the training unit 570 trains the parameters used by the target estimation unit 540 based on the center position error and the size error of the eye. The specific training method is as described earlier. For example, the training unit 570 may perform the training processing through error back-propagation. The other processing can be performed as described earlier. In this manner, the training unit 570 can train the parameters of the trained model based on the maps obtained by inputting the training images into the trained model trained to estimate the closer part in the image and the size ground truth map of the eye that is closer to the camera.

As described above, in the present variation, the part of the first type (e.g., the eye) that is closer to the image capturing apparatus is detected by directly estimating the part of the first type that is closer to the image capturing apparatus. This configuration is expected to improve the accuracy of detecting the part of the first type that is closer to the image capturing apparatus even when the second part is hidden.

### Other Embodiments

In the foregoing embodiment, the part of the first type is detected and the size of the part of the first type is detected. However, it is not necessary to detect the size of the part of the first type in order to quickly detect the part that is closer to the image capturing apparatus. As such, it is not necessary for the neural networks illustrated in FIGS. 4, 9, and 12 to have the networks 422, 822, and 1222 for detecting the size of the eye. It is also not necessary to perform the training using the size ground truth map.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-210202, filed Dec. 27, 2022, which is hereby incorporated by reference herein in its entirety.

What is claimed is:

1. An image processing apparatus comprising one or more memories storing instructions and one or more processors that execute the instructions to:
perform first position estimation of detecting one or more parts of a first type in an image;
estimate a distance between each of the one or more parts of the first type and a part of a second type in the image;
select, from among the one or more parts of the first type detected, one part of the first type, based on the distance estimated for each of the parts of the first type; and
output information indicating the part selected.

2. The image processing apparatus according to claim 1, wherein the one or more processors execute the instructions to estimate the distance using a map indicating a distance to the part of the second type for each of the one or more parts of the first type in the image, the map being obtained using a trained model.

3. The image processing apparatus according to claim 1, wherein the one or more processors execute the instructions to:
perform second position estimation of detecting a part of a second type in the image; and
determine a distance between each of the one or more parts of the first type detected from the image and the part of the second type detected from the image.

4. The image processing apparatus according to claim 1, wherein the distance estimated for the one part of the first type selected is longer than the distance estimated for another part among the one or more parts of the first type.

5. The image processing apparatus according to claim 1, wherein the one or more processors execute the instructions to:
detect two parts of the first type; and
select a method for selecting one part among the two parts based on a difference in distances from each of the two parts to the part of the second type.

6. The image processing apparatus according to claim 5, wherein the one or more processors execute the instructions to:
select a first method for selecting the one part based on a comparison of the distances from each of the two parts to the part of the second type, when the difference is at least a threshold; and
select a second method different from the first method when the difference is less than the threshold.

7. The image processing apparatus according to claim 6, wherein the one or more processors execute the instructions to:
select, from a plurality of the parts of the first type detected from a past image captured at a time before the image, one part of the first type; and
select, in the second method, the one part among the two parts based on a position of the one part of the first type selected from the plurality of the parts of the first type detected from the past image.

8. The image processing apparatus according to claim 1, wherein the part of the second type is a part that is equidistant from the one or more parts of the first type.

9. The image processing apparatus according to claim 1, wherein the part of the second type is a nose, a mouth, a chin, a brow, or a head.

10. An image processing apparatus comprising one or more memories storing instructions and one or more processors that execute the instructions to:
obtain an image; and
detect a part of a first type in an image that is a closer part closer to an image capturing apparatus that captured the image than another part of the first type in the image, using a trained model having parameters trained to estimate the closer part in an image, and output information indicating a detection result.

11. The image processing apparatus according to claim 10, wherein the trained model outputs a map indicating a likelihood that the closer part is present for the image.

12. The image processing apparatus according to claim 11, wherein the parameters are trained based on a map obtained by inputting into the trained model a training image including a plurality of parts of the first type, and a ground truth map in which is labeled a position corresponding to a part, among the plurality of parts of the first type in the training image, selected such that a distance from the part to a part of a second type is longer than a distance from the other part of the first type to the part of the second type.

13. The image processing apparatus according to claim 1, wherein the part of the first type is an eye or an ear.

14. The image processing apparatus according to claim 1, wherein the one or more processors execute the instructions to detect a frame corresponding to a third part in the image and detect the part of the first type from within the frame.

15. The image processing apparatus according to claim 14, wherein the third part is a face, a head, or a person.

16. An image processing apparatus according to claim 1, further comprising an image capture unit configured to capture the image,
wherein the one or more processors execute the instructions to control the image capture unit so as to bring the one part of a first type that has been selected into focus.

17. A method of generating a trained model having parameters trained to be used to estimate a distance between a part of a first type and a part of a second type in an image, the method comprising:
obtaining (i) a training image and (ii) a ground truth map in which information indicating the distance between each of the part of the first type and the part of the second type is provided at a position corresponding to the part of the first type in the training image; and
training the parameters of the trained model based on (i) a map indicating the distance from the part of the first type to the part of the second type in the training image, the map being obtained by inputting the training image into the trained model, and (ii) the ground truth map.

18. A method of generating a trained model having parameters trained to be used to estimate a position of a part of a first type in an image, the part being closer to an image capturing apparatus that captured the image than another part of the first type in the image, the method comprising:
obtaining (i) a training image including a plurality of parts of the first type and (ii) a ground truth map in which is labeled a position corresponding to a part, among the plurality of parts of the first type in the training image, selected such that a distance from the part to a part of a second type is longer than a distance from the other part of the first type to the part of the second type; and
training the parameters of the trained model based on (i) a map indicating a likelihood that a part closer to the image capturing apparatus that captured the image than the other part of the first type is present for the training image, the map being obtained by inputting the training image into the trained model; and (ii) the ground truth map.

19. An image processing method comprising:
performing first position estimation of detecting one or more parts of a first type in an image;
estimating a distance between each of the one or more parts of the first type and a part of a second type in the image;
selecting, from among the one or more parts of the first type detected, one part of the first type, based on the distance estimated for each of the parts of the first type; and
outputting information indicating the part selected.

20. A non-transitory computer-readable medium storing one or more programs which are executable by a computer comprising one or more processors and one or more memories to perform a method comprising:
performing first position estimation of detecting one or more parts of a first type in an image;
estimating a distance between each of the one or more parts of the first type and a part of a second type in the image;
selecting, from among the one or more parts of the first type detected, one part of the first type, based on the distance estimated for each of the parts of the first type; and
outputting information indicating the part selected.
